(19) United States
(12) Patent Application Publication
(10) Pub. No.: US 2007/0207809 A1
(43) Pub. Date: Sep. 6, 2007

(54) Networking corridors for packet data and voice communications

(76) Inventor: Steven Luzima Mutabazi, Mitcham, VIC (AU)

Correspondence Address: AKERMAN SENTERFITT, P.O. BOX 3188, WEST PALM BEACH, FL, 33402-3188, US

(21) Appl. No.: 10/564,898

(22) PCT Filed: Jul. 14, 2004
(86) PCT No.: PCT/AU04/00941

§ 371 Date: Jun. 27, 2006

(30) Foreign Application Priority Data
Jul. 14, 2003 (AU) 2003903602

(51) Int. Cl. H04Q 7/20

(52) U.S. Cl. 455/447

(57) ABSTRACT

A data and voice digital communication network installation and networking method, including a plurality of packet communication networking hubs, logically configured in a hierarchy of at least two tiers, a transmission backbone network linking said hubs, including at least one light transmitting fibre with means to extract signals from and apply signals to the fibre which are at least a proportion of end to end signals being carried by the fibre, said signals being extracted to and received from the packet communications networking hubs, at a plurality of selected locations, including at least one which is not located at a primary hub, wherein the logical configuration of a given hub is substantially independent of its physical connectivity to the transmission backbone network.

### CROSS-REFERENCE TO RELATED APPLICATIONS

This is the U.S. National Stage of PCT/AU2004/000941 filed 14 Jul. 2004, which claims priority from Australian Patent Application No. 2003903602 filed 14 Jul. 2003.

### TECHNICAL FIELD

This invention relates to a method and installation for providing Wide Area Network (WAN) connectivity for geographically dispersed sites. In particular it relates to the provision of WAN connectivity in the context of geography such as may typically apply in countries of widely separated major cities and regional population centres. The invention has particular application to Australia and will be generally described with reference to this country but it is not intended that in its broader concept that the invention should be so limited to a single country.

### BACKGROUND

Conventionally, WAN connectivity is provided by providing a series of capital city based WAN hubs using inter-capital transmission infrastructure for inter-hub connectivity, with variable length, but on average long, point-to-point dedicated services to provide site-to-hub connectivity, where signals from one of the capital city hubs is transmitted directly and indeed only to the other end of that particular backbone connection which terminates on a hub of another capital city.

Further, such a backbone which is intended to carry high bandwidth information is set up as a dedicated circuit based channel system.

By this we mean that any communication requires a channel to be allocated for the transmission of a particular transmission purpose and each of a number of channels will be variously allocated to then be dedicated to transmit whatever information be this voice or data is provided.

Such a backbone connection can provide very fast communication speeds from main city hub to main city hub and then geographically distant places are then connected by dedicated circuit based channels directly connecting the remote place to the closest hub.

There may be secondary hubs emanating from a main city hub but the system in existence at the present time in Australia is therefore a system based upon dedicated circuit based channels which will carry signals very quickly indeed along the backbone that may or may not transmit such signals at such a high rate to secondary hubs or even tertiary hubs or hub to point connections.

The difficulty with such an arrangement is that costs chargeable with respect to transmission of a signal necessarily relate to the capital cost of the equipment installed in order to transmit the signals and this can be directly dependent then upon the distance and also the switching hubs that a signal might have to go to in order to go from one point geographically in Australia to another point geographically spaced apart in Australia.

Because of the current way that network in existence in Australia operates, secondary or tertiary networking elements are directly connected to a nearest capital city hub. For a country town then, in Victoria for instance, to communicate with a country town in New South Wales, the signal from the Victorian country town is firstly directed to a first transit transmission hub which we are terming a tertiary hub, then through a secondary hub and then to a capital city hub in Melbourne which is then conveyed through a dedicated circuit based channel on the backbone to Sydney from whence again it will be then directed out by way of switching allocated channels to a secondary and tertiary hub and eventually to the location of the geographically remote region such as a small country town.

However, the two country towns can be simply on opposite sides of a border between Victoria and New South Wales which may be only several kilometres apart.

Nonetheless, the cost of communication passed on to the customer has to take into account the amount of equipment necessary in order to transmit that signal and has to therefore be very high indeed even though the physical distance apart of the two townships can be very small.

This description is intended to describe in a general sense a current system that is currently operating in Australia and which has the effect of establishing significant costs of using the communication network.

A first problem therefore exists that when using dedicated circuit based channel transmission techniques that it is also an economic challenge to put such equipment that is necessary to effect such switching of channels and effecting transmission at high speed along those channels at anywhere but main city hubs. This is a very expensive process in itself and also if a backbone connection was to be between geographically closer hubs then there is necessarily a very high equipment installation cost, significant potential difficulties with increased capital cost on a very high speed backbone with potential increase in challenge to any reliability.

Generally then it does seem that the use of a high speed dedicated circuit based channel backbone between only capital cities (or at least major population centres which can justify infrastructure costs) is the current solution considering the capital cost economics as applied to this type of technology.

It does have a problem that if for any reason the backbone connection should fail, then literally all communication based upon this system between two states in Australia would also cease. The problem, therefore, in this currently existing system, is that it implicitly causes very high costs of communication to many outlying country towns. Accordingly, there is a need to re-evaluate the current situation, particularly in Australia, although the problem will be similar elsewhere.

### SUMMARY OF THE INVENTION

It has been discovered that by using an alternative networking technique for a backbone this can allow for dramatically reduced costs described. By allowing intermediate connections to be made without incurring the very high infrastructure costs achieves this and further the technique for transmission facilitates an installation with much improved potential reliability.

Further, I have realised that this can be provided in a way that has less vulnerability to being cut off than is the case with the current system.

It is an object of this invention to provide at least some improvement over the current system or at least provide the public with a useful alternative.

The invention is to provide a backbone networking route based upon transmission using addressed digital logic packets and to provide a speed of transmission that will facilitate both voice as well as data signals being transmitted and that this can then also allow for voice quality and continuity being of an acceptable standard for public telecommunication purposes.

A first advantage of this is that even an extremely high speed backbone route can be intersected very economically providing a further intermediary hub or can be connected to a spur.

Further, such an arrangement facilitates again with addressed digital packet transmission switching most hubs being able to route signals through at least two alternate paths so that in the event that one of these paths is destroyed, the other remains viable. This “protection” is traditionally provided by significant, sometimes complete, duplication of infrastructure. In the arrangement of the invention, such protection is inherent without the need for additional infrastructure.

With this arrangement then, it becomes very economic to provide widely scattered locations through the country with both high speed data connection and voice communication at a very good, if not excellent quality, which will no longer require that the signals pass through a plurality of switching stations with the attendant long routes and expensive equipment necessary for this.

A typical speed of communication that will provide the quality of voice communication and at the same time, excellent data transmission for signals other than voice or equivalent signals, is 2.5 gigabits per second.

This is indicative of speeds that can currently be achieved with light fibres and in real terms, significantly higher speeds can be now achieved if useful with the amount of communication.

From an economic point of view in Australia, it has been established that a communication through a backbone using at least 2.5 gigabits per second transmission rate of addressed digital packet logic would enable an enormous number of places geographically spread throughout a region such as Australia to be connected at relatively low cost to a very high speed connection which can be used both for conventional voice communication or it can also be used for internet or other digital transmission systems.

In the case specifically of Australia, it has been established that there are currently light fibre connections available between at least two capital cities, which are currently only being used for data transmission.

Further, this is being used in the conventional mode, that is that it is being used for end to end traffic only for digital data.

It also has been established that an installation can be used in a dramatically improved way providing very much needed communication at much higher speeds and at very high economies to most of the outer lying locations in Australia at costs which will be able to be accessed at very competitive economic rates.

The invention provides a very high speed addressed digital packet logic incorporating and providing with that logic transmission both for general data and voice equivalent transmissions (voice equivalent transmissions means those signals that will normally be transmitted for use as analogue signals eventually) and where, in connection with such a high speed communication which at the least provides for communication from end to end at this speed, will also have at least one intermediary take off providing either a spur connection to an intermediary hub or a hub as part of the connection.

Currently, such high speed connections are effected through light transmitting fibres and, therefore, the invention can further characterized by being directed to at least one light transmitting fibre effective for carrying the signals and indeed carrying the signals and having some intermediary take off.

It is relevant that the invention is directed to a backbone communication system which will enable these significant improvements to be achieved in a general telecommunication system.

It currently, in most cases, is uneconomic to provide direct connections to an end user other than through installed equipment such as that which is currently provided by a telecommunication operator such as Telstra in Australia.

Given that the invention involves signals which are addressed digital packets, it is viable, both from a technical and economic point of view, to route these through a local telecommunication network for perhaps distribution to each end user at a local level.

Such communication would normally be by way of dedicated circuit based channel communication although it is not especially relevant to this invention as to what the end user connection might be.

For instance, for a larger user, there could be a direct connection and for smaller users, a connection via a router into the distributed mesh system in accordance with this invention.

Such an interconnection might therefore be with an appropriate gateway controlled interconnection at a local exchange, or at a customer premises aggregation point, which could be called a neighbourhood hub.

It can be said then that the invention could be said to reside in a data and voice digital communication network installation providing a backbone communication bandwidth solely through addressed digital logic packets of at least 2.5 gigabytes/second between geographically substantially dispersed locations being primary hubs, and having at least one light transmitting fibre through which the transmission is effected with means at respective ends, being the primary hubs, of the fibre to effect an input and output of the communication signals at a rate which is at least the said bandwidth, and further having at least one intermediate means being a secondary hub which is substantially geographically dispersed from said locations of the primary hubs to effect an input and output through addressed digital logic packets into the fibre, and means to then effect transmission of and signals from said secondary hub to a further geographically dispersed location at a rate which is less than the said bandwidth between said primary hubs.

In a further form the invention may be said to reside in a data and voice digital communication network installation including a plurality of packet communication networking hubs, logically configured in a hierarchy of at least two tiers, a transmission backbone network linking said hubs, including at least one light transmitting fibre with means to extract signals from and apply signals to the fibre which are at least a proportion of end to end signals being carried by the fibre, said signals being extracted to and received from the packet communications networking hubs, at a plurality of selected locations, including at least one which is not located at a primary hub, wherein the logical configuration of a given hub is substantially independent of its physical connectivity to the transmission backbone network.

In preference, a logical connectivity scheme is constructed and is operated so that it provides a first logical connectivity mesh linking each of a plurality of hubs comprising a first hierarchical tier of hubs, at least one second connectivity mesh linking each of a plurality of hubs comprising a second hierarchical tier of hubs to at least two hubs of said first tier.

In preference, said logical connectivity scheme further includes point to point connectivity between each of a plurality of hubs comprising a third hierarchical tier of hubs and at least one hub from a higher hierarchical tier and point to point connectivity between any hub and selected locations external to the communication network scheme.

In a yet further form, the invention may be said to reside in a method of operating a data and voice digital communication network including a plurality of packet communication networking hubs, logically configured in a hierarchy of at least two tiers, a transmission backbone network linking said hubs, including at least one light transmitting fibre, extracting signals from and applying signals to the fibre which are at least a proportion of end to end signals being carried by the fibre, said signals being extracted to and received from the packet communications networking hubs, at a plurality of selected locations, including at least one which is not located at a primary hub, wherein the logical configuration of a given hub is substantially independent of its physical connectivity to the transmission backbone network.

In preference there is undertaken the construction and operation of a logical connectivity scheme including a first logical connectivity mesh linking each of a plurality of hubs comprising a first hierarchical tier of hubs, at least one second connectivity mesh linking each of a plurality of hubs comprising a second hierarchical tier of hubs to at least two hubs of said first tier.

Preferably, there is point to point connectivity between each of a plurality of hubs comprising a third hierarchical tier of hubs and at least one hub from a higher hierarchical tier and point to point connectivity between any hub and selected locations external to the communication network scheme.

In a preferred arrangement there is a data and voice digital communication network installed in Australia providing for at least one communication network between Sydney and Melbourne which provides for a bandwidth of at least approximately 2.5 gigabits per second and has at least one intermediate node where the communication method is solely directed toward addressed digital packet transmission where both the digital and voice communication over such a backbone connection is by way of such addressed digital logic packets.

In a preferred arrangement there is a data and voice digital communication network installation covering the geography of Australia providing a backbone communication bandwidth solely through addressed digital logic packets of at least 2.5 gigabytes/second between geographically substantially dispersed locations being primary hubs, and having at least one light transmitting fibre through which the transmission is effected with means at respective ends, being the primary hubs, of the fibre to effect an input and output of the communication signals at a rate which is at least the said bandwidth, and further having at least one intermediate means being a secondary hub which is substantially geographically dispersed from said locations of the primary hubs to effect an input and output through addressed digital logic packets into the fibre, and means to then effect transmission of and signals from said secondary hub to a further geographically dispersed location at a rate which is less than the said bandwidth between said primary hubs.

In a preferred arrangement an economical communications carriage infrastructure includes packet communication networking hubs, configured as primary, secondary and tertiary hubs, geographically positioned to achieve economically optimum coverage and a transmission backbone network including at least one light transmitting fibre with means to extract signals from and apply signals to the fibre which are at least a proportion of end to end signals being carried by the fibre, said signals being extracted to and received from the packet communications networking hubs, at a plurality of selected locations, including at least one which is not located at a termination point of the fibre.

In a preferred arrangement, a logical connectivity scheme is constructed and is operated so that it provides a primary connectivity mesh linking primary hubs, at least one secondary connectivity mesh linking each secondary hub to at least two primary hubs, point to point connectivity between each tertiary hub and either one primary hub or one secondary hub or both and point to point connectivity between any hub and selected locations external to the communication network scheme.

The invention can be directed to both a method of operating a telecommunication network or an installation for providing a telecommunication network for both data and voice and voice equivalent transmission.

It would be expected that such a communication system would be directed at least along the backbone and directly interconnected mesh connections using solely addressed digital logic packet technology.

Preferably, the invention applies specifically to installations in Australia and provides for at least one communication network between Sydney and Melbourne which provides for a bandwidth of at least approximately 2.5 gigabits per second and has at least one intermediate node where the communication method is solely directed toward addressed digital packet transmission where both the digital and voice communication over such a backbone connection is by way of such addressed digital logic packets.

### BRIEF DESCRIPTION OF THE DRAWINGS

There are shown in the drawings, embodiments which are presently preferred. It is to be understood, however, that the invention is not limited to the precise arrangements and instrumentalities shown.

FIG. 1 is a schematic diagram that illustrates the current networking backbone system, and hub connectivity system, according to one embodiment of the invention.

FIG. 2 is a schematic diagram that illustrates how there can be provided now, very economically, a networking backbone corridors system, according to one embodiment of the invention.

FIG. 3 is a schematic diagram that illustrates how such a networking backbone corridors system can enable an economical but very high bandwidth hub connectivity system for Australia, according to one embodiment of the invention.

FIG. 4 is a schematic diagram of an exemplary network having networking backbone corridors system that can be used to incorporate more hubs and to create bandwidth aggregation points for connections to multiple customers, according to one embodiment of the invention.

FIG. 5 is a schematic diagram that illustrates an extended high bandwidth hub connectivity system, according to one embodiment of the invention.

FIG. 6 is a schematic diagram that illustrates how this method can be applied to the city of Melbourne, according to one embodiment of the invention.

FIG. 7 is a schematic diagram that illustrates a possible physical connectivity diagram according to the invention, according to one embodiment of the invention.

FIG. 8 is a schematic diagram that shows the corresponding logical connectivity diagram for the network of FIG. 7, according to one embodiment of the invention.

### BEST MODE FOR CARRYING OUT THE INVENTION

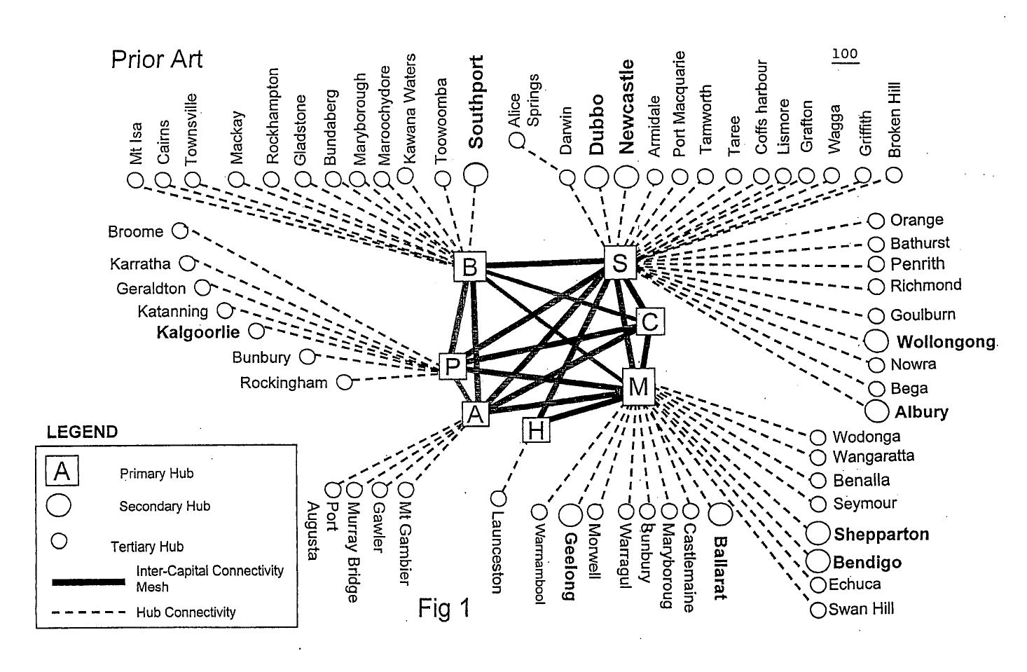

Referring in detail to the drawings, FIG. 1 schematically illustrates the current networking backbone system 100 based on high a bandwidth inter-capital transmission backbone comprised of dedicated circuit based channels, providing connectivity between some of Australia's capital city hubs, and transmission backbones linking out-lying hubs to the capital city hubs. In this networking backbone system, provision of sufficiently high transmission speeds for carriage of data and voice traffic to and from hubs outside the capital cities is uneconomical and is therefore only attempted when high traffic volumes are to be carried. For example, high transmission speeds between Sydney and out-lying hubs such as Griffith, Armidale, and Dubbo would be uneconomical.

These high volume high traffic links are typically provided by long-haul dense wavelengths division multiplexing (DWDM) transmission systems. These systems distribute bandwidth to terminating sites in the form of whole wavelengths. Such wavelengths have a capacity in the order of 2.5 gigabits per second.

These constraints in transmission backbone speeds have resulted in the current hub connectivity system. In this hub connectivity system it can be seen that high bandwidth connectivity is possible for inter-capital hub connectivity, but for other hubs it is constrained by the distance-dependent pricing of the transmission backbones between these hubs and their respective capital city hubs.

These transmission backbones are provided using, at the primary hubs, DWDM transmission systems capable of transmitting one or many wavelengths. Multiple services may be aggregated into a single wavelength for this transmission.

However, interconnectivity can be provided only at the level of a full wavelength. That is, any terminal must receive or insert a full wavelength or whole optical channel. This means it is only possible to provide bandwidth in large blocks which cannot be economically utilised by smaller traffic generators, in particular, Australian towns, smaller than the capital cities.

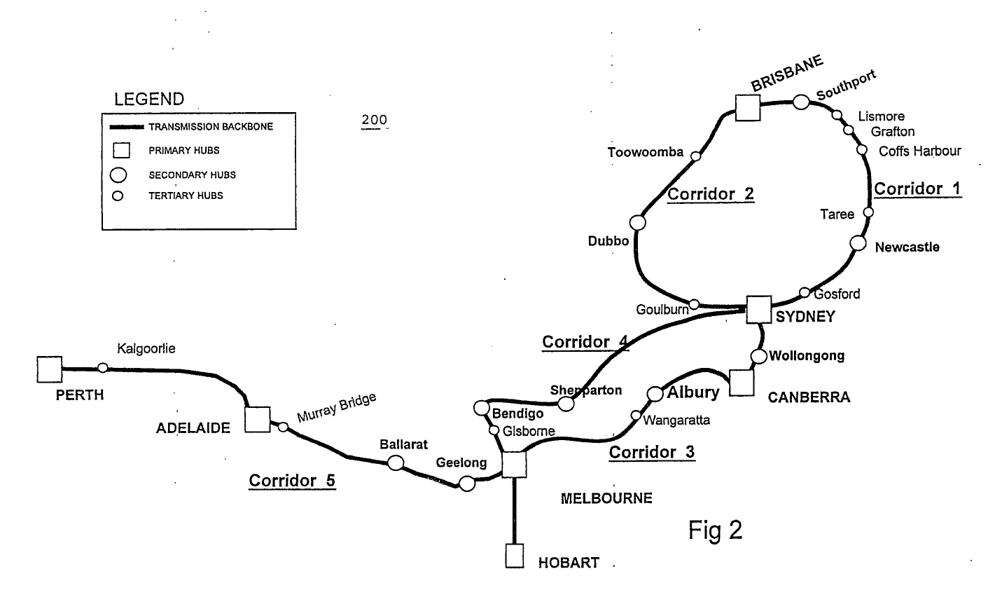

In contrast to the current networking backbone system illustrated in FIG. 1, and referring specifically to FIG. 2, a system 200 according to the present invention is schematically illustrated in an exemplary environment, the country of Australia. Illustratively, between Brisbane and Sydney, Australia, there are two parallel connections termed Corridor 1 and Corridor 2 and that in each of these, there are a number of intermediary hubs from which further direct connections can be made to more localised locations.

The same can be seen to be that position with connections between Sydney and Melbourne where there are now two routes, namely Corridor 3 and Corridor 4, which respectively go through a number of smaller hubs and towns, for instance Corridor 3 goes through Wollongong, and then to Canberra, Albury, Wangaratta and Corridor 4 goes from Sydney to Shepparton, Bendigo, Gisborne and then Melbourne.

A single Corridor 5, connects from Melbourne through Adelaide to Perth, and in this case, an intermediary connection between Melbourne and Adelaide can be in Geelong and Ballarat.

An intermediary connection between Adelaide and Perth can be at Kalgoorlie, but of course, there can be a number of further intermediary hubs which will be of relatively small cost and provide those connections with very high quality and high speed voice and digital communication.

These primary hubs are connected by conventional DWDM transmission platforms.

With a secondary connectivity mesh which may be at a somewhat lesser speed than would be available through light transmitting fibres, there can now be seen to be a number of interconnections that can be made which provide still very high quality communication even though the quantity of traffic might be less.

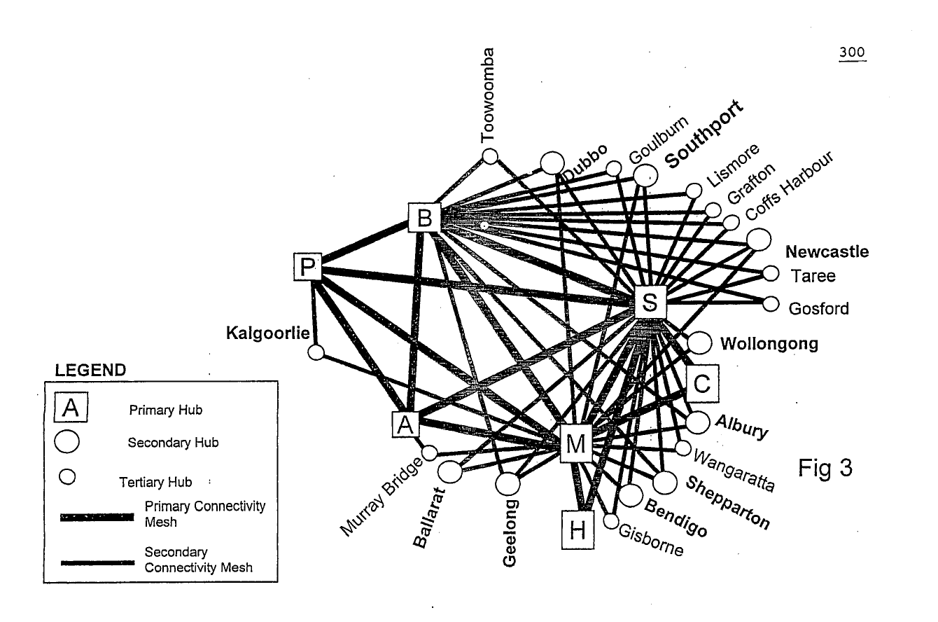

FIG. 3 schematically illustrates high bandwidth connectivity 300 for both secondary and tertiary hubs that now becomes possible again at very significant cost savings.

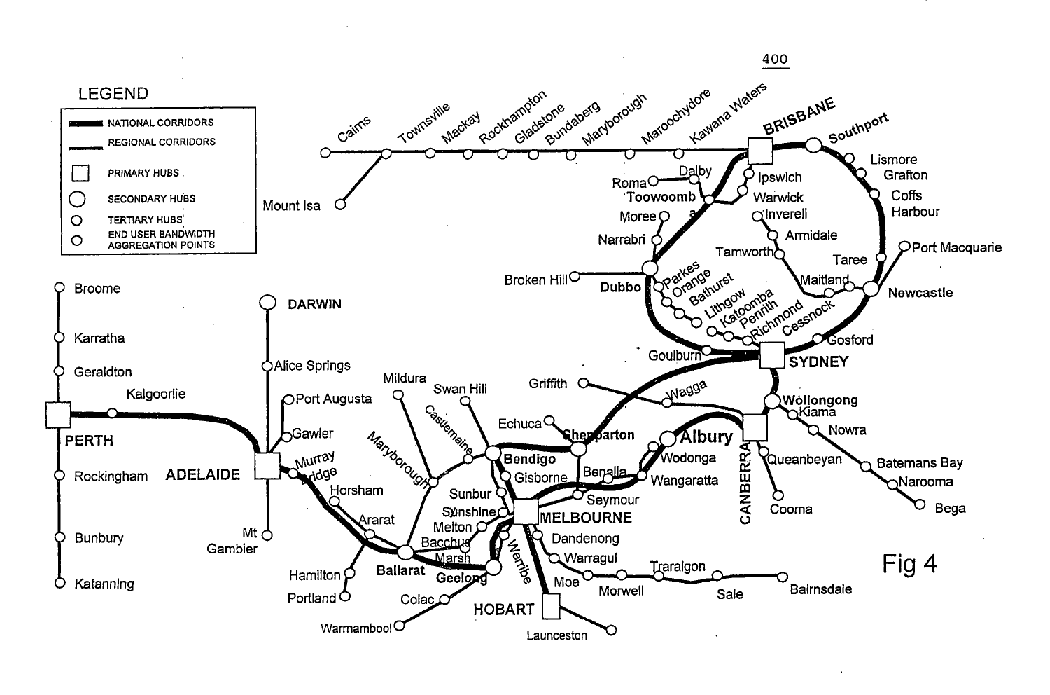

FIG. 4 schematically illustrates a networking configuration 400 in which the networking backbone corridors system can be used to incorporate more hubs and to create bandwidth aggregation points for connections to multiple customers.

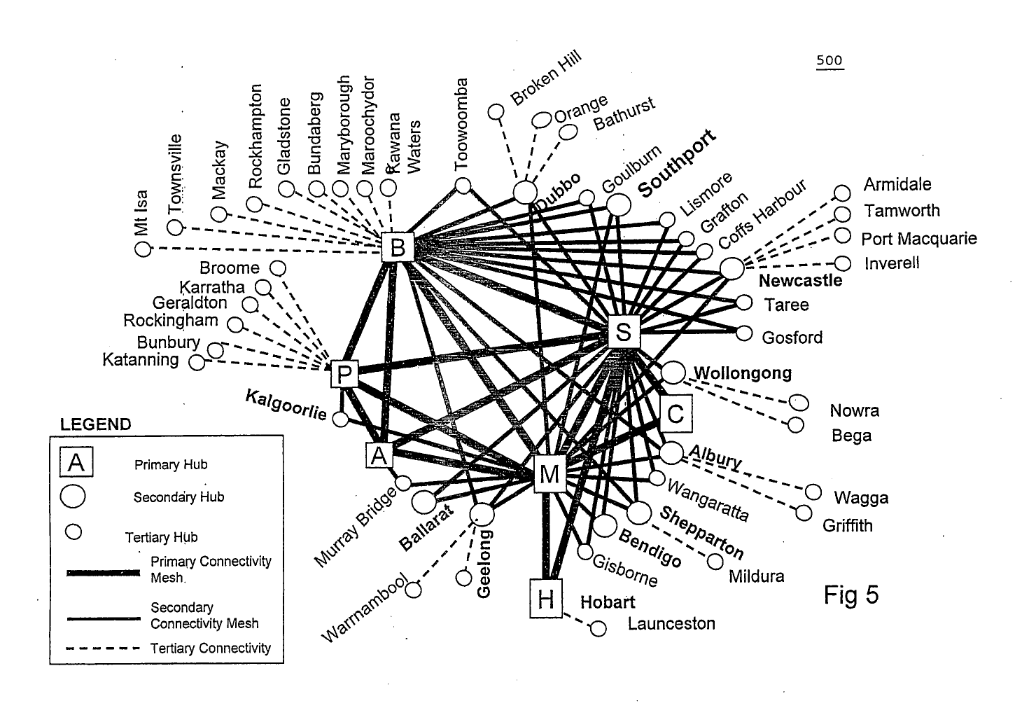

It is then possible to establish an extended high bandwidth hub connectivity system 500 such as schematically illustrated in FIG. 5. The same mechanism of high bandwidth networking backbone corridors can further be applied to the geographic area of a capital city.

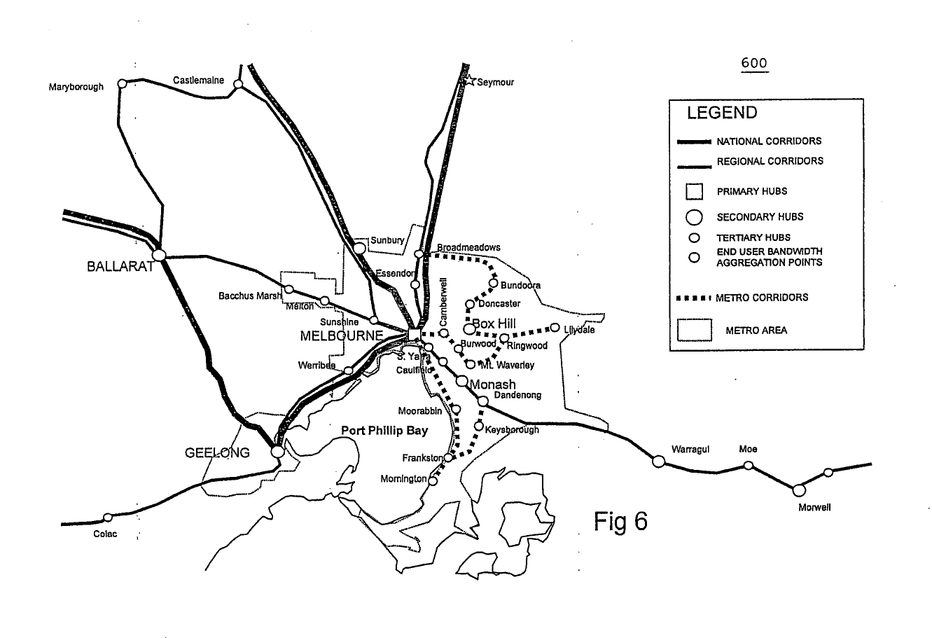

FIG. 6 schematically illustrates a network 600, the underlying mechanism of which can be applied to the city of Melbourne, thereby further extending the national and regional networking backbone corridors system, to include a specific metro networking backbone corridors system that is appropriately integrated with the former.

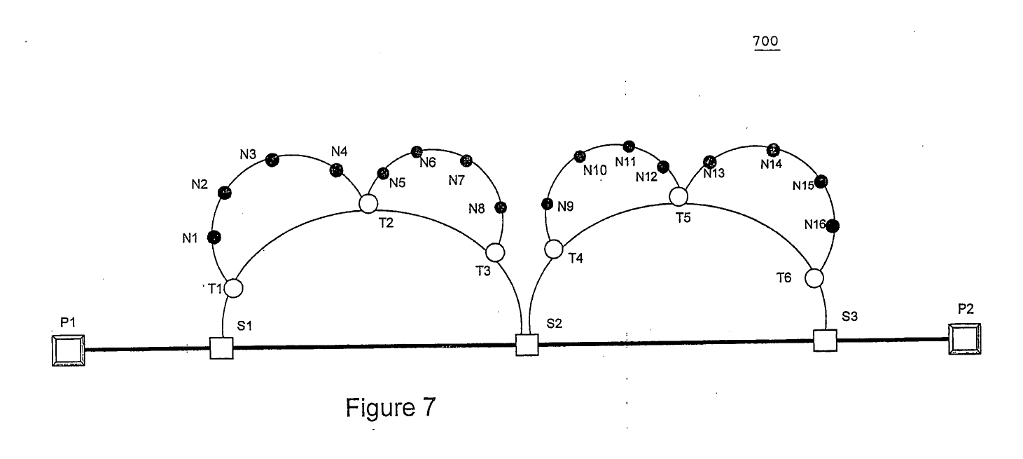

FIG. 7 schematically illustrates the physical connectivity in a network 700 including four tiers, where a further set of hubs, called in this instance neighbourhood hubs, is included. A first hierarchical tier of hubs, P1 and P2, called primary hubs is connected physically by optical fibre, via a number of hubs of a second hierarchical tier called secondary hubs, S 1-3. A third hierarchical tier of hubs, Ti-6, called tertiary hubs is connected to each other or to secondary hubs. The neighbourhood hubs, Ni-i 6 form a fourth hierarchical tier.

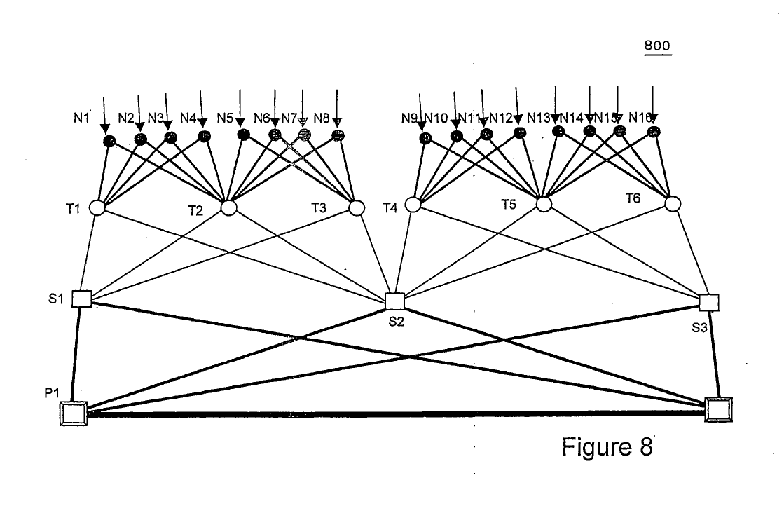

The logical connectivity for this physical system is shown in the network 800 of FIG. 8. Logically each hub in a tier has connections to two hubs in the next higher tier.

The tertiary hubs can be connected by using currently installed infrastructure except that the connection's distance to a main hub or to a sufficiently high speed connecting hub is very much less than has hitherto been the case in existing telecommunication networks.

What can now be seen to have been provided is a communication network method and installation which provides for a economical communications carriage to carry both data and voice and voice like signals solely as addressed digital logic packets by providing this at least in a backbone system and distributed mesh networks such that the speed of communication will be sufficient to provide very good voice or other equivalent analogue signal transmissions as well as data.

This is provided by a transmission speed of at least approximately 2.5 gigabits per second along a main backbone and uniquely capable, and in fact having intermediary connections providing for mesh communication networks both for primary and secondary networks where secondary would be normally at a transmission speed that might be a proportion only of the main backbone communication bandwidth.

As would be appreciated by those skilled in the art, this transmission speed of 2.5 gigabits per second is provided in a DWDM system by using a full wavelength. Thus the proportion only of the main backbone communication bandwidth is provided by a part only of a bandwidth. It is therefore the case that secondary, tertiary and neighbourhood hubs are capable of dropping and inserting from and to the main back-bone, communication channels which are less than a full wavelength.

As also noted already, the invention can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1-10. (canceled)

11. A data and voice digital communication network installation providing a backbone communication bandwidth, said network installation comprising:
optical transmission means for transmitting communications signals consisting of addressed digital logic packets of at least 2.5 gigabits per second between geographically dispersed primary hubs and having a capacity of one wavelength;
at least one light transmitting fibre through which the transmission is effected between said primary hubs;
means positioned at said primary hubs for effecting an input and output of the communication signals at a rate which is at least said bandwidth;
at least one intermediate means, defining a secondary hub which is substantially geographically dispersed from said primary hubs, to effect an input and output through addressed digital logic packets into the fibre; and
means for effecting transmission and receiving of signals from said secondary hub to a further geographically dispersed location at a rate less than said bandwidth between said primary hubs;
wherein said secondary hub is configured to provide the lesser bandwidth rate by providing access to a proportion of the backbone communication bandwidth which is less than one wavelength.

12. A data and voice digital communication network installation including a plurality of packet communication networking hubs, logically configured in a hierarchy of at least two tiers, the network installation comprising a transmission backbone network linking said hubs, wherein said linking includes at least one light transmitting fibre and having means to extract signals from and apply signals to the fibre with at least a proportion of end to end signals being carried by the fibre, said proportion being less than a single wavelength being carried by the transmission backbone, said signals being extracted to and received from the packet communications networking hubs, at a plurality of selected locations, including at least one of which is not located at a primary hub, and wherein the logical configuration of a given hub is substantially independent of its physical connectivity to the transmission backbone network.

13. A data and voice digital communication network installation as in claim 12, wherein a logical connectivity scheme is configured and operated to provide a first logical connectivity mesh linking each of a plurality of hubs comprising a first hierarchical tier of hubs, at least one second connectivity mesh linking each of a plurality of hubs comprising a second hierarchical tier of hubs to at least two hubs of said first tier.

14. A data and voice digital communication network installation as in claim 13, wherein said logical connectivity scheme further includes point-to-point connectivity between each of a plurality of hubs comprising a third hierarchical tier of hubs and at least one hub from a higher hierarchical tier and point-to-point connectivity between any hub and selected locations external to the communication network scheme.

15. A data and voice digital communication network, comprising:
a plurality of packet communication networking hubs, logically configured in a hierarchy of at least two tiers; and
a transmission backbone network linking said hubs, including at least one light transmitting fibre, extracting signals from and applying signals to the fibre which are at least a proportion of end-to-end signals being carried by the fibre, said proportion being less than a single wavelength being carried by the transmission backbone, said signals being extracted to and received from the packet communications networking hubs, at a plurality of selected locations, including at least one which is not located at a primary hub, wherein the logical configuration of a given hub is substantially independent of its physical connectivity to the transmission backbone network.

16. A data and voice digital communication network as in claim 15, further including the construction and operation of a logical connectivity scheme including a first logical connectivity mesh linking each of a plurality of hubs comprising a first hierarchical tier of hubs, at least one second connectivity mesh linking each of a plurality of hubs comprising a second hierarchical tier of hubs to at least two hubs of said first tier.

17. A data and voice digital communication network as in claim 16, wherein said logical connectivity scheme further includes point-to-point connectivity between each of a plurality of hubs comprising a third hierarchical tier of hubs and at least one hub from a higher hierarchical tier and point-to-point connectivity between any hub and selected locations external to the communication network scheme.

18. A data and voice digital communication network comprising:
at least one intermediate node; and
a backbone connection connected to said at least one intermediate node for effecting both digital and voice communication solely directed toward providing addressed digital packet transmission, wherein both digital and voice communication over such said backbone connection is by way of such addressed digital logic packets, wherein said at least one intermediate node is configured to provide access to a proportion of the backbone bandwidth being less than a full wavelength, and wherein said communication network is installed in Australia to provide at least one communication network between Sydney and Melbourne which provides for a bandwidth of at least approximately 2.5 gigabits per second.

19. A data and voice digital communication network installation covering the geography of Australia providing a backbone communication bandwidth of at least 2.5 gigabytes/second between geographically substantially dispersed locations being primary hubs, and having at least one light transmitting fibre through which the transmission is effected with means at respective ends, defining primary hubs, of the fibre to effect an input and output of the communication signals at a rate which is at least the said bandwidth, and further having at least one intermediate means being a secondary hub which is substantially geographically dispersed from said locations of the primary hubs to effect an input and output through addressed digital logic packets into the fibre, and means to then effect transmission of and signals from said secondary hub to a further geographically dispersed location at a rate which is less than the said bandwidth between said primary hubs, said secondary hub being adapted to provide this lesser bandwidth rate by providing access to a proportion of the backbone communication bandwidth which is less than one wavelength.

20. A method of communicating data and voice signals via a digital communication network installation providing a backbone communication bandwidth, said method comprising:
transmitting, via optical transmission means, communications signals consisting solely of addressed digital logic packets of at least 2.5 gigabits per second between geographically dispersed primary hubs and having a capacity of one wavelength;
providing at least one light transmitting fibre through which the transmission is effected between said primary hubs;
providing means positioned at said primary hubs for effecting an input and output of the communication signals at a rate which is at least said bandwidth;
providing at least one intermediate means, defining a secondary hub which is substantially geographically dispersed from said primary hubs, to effect an input and output through addressed digital logic packets into the fibre;
providing means for effecting transmission and receiving of signals from said secondary hub to a further geographically dispersed location at a rate less than said bandwidth between said primary hubs; and
configuring said secondary hub to provide the lesser bandwidth rate by providing access to a proportion of the backbone communication bandwidth which is less than one wavelength.
